(19) United States
(12) Patent Application Publication
(10) Pub. No.: US 2020/0007218 A1
(43) Pub. Date: Jan. 2, 2020

(54) TAG WITH ORIENTATION INDEPENDENT ANTENNA

(71) Applicant: Antenum LLC, Merrimack, NH (US)

(72) Inventors: James D. Logan, Candia, NH (US); John T. Apostolos, Lyndeborough, NH (US); William Mouyos, Windham, NH (US)

(21) Appl. No.: 16/440,059

(22) Filed: Jun. 13, 2019

Related U.S. Application Data
(63) Continuation-in-part of application No. 15/861,739, filed on Jan. 4, 2018.

(51) Int. Cl. H04B 7/06; G08B 21/24

(52) U.S. Cl. CPC H04B 7/0695; G08B 21/24

(57) ABSTRACT

A tag incorporated with a directional antenna. Directional antennas may utilize devices equipped with orientation-independent antennas to determine the location of radio frequency signals emitted by other objects. The system can exist in many different customizable configurations, sometimes utilizing orientation-independent antennas embedded in the tag.

### CROSS REFERENCE TO RELATED APPLICATIONS

This application claims priority to U.S. Provisional Patent Ser. No. 62/684,625 filed Jun. 13, 2018 entitled “Tag with Orientation Independent Antenna” and is a continuation in part of a co-pending U.S. patent application Ser. No. 15/861,739 filed Jan. 4, 2018 entitled “Indoor Positioning System Utilizing Beamforming with Orientation- and Polarization-Independent Antennas”, the entire contents of each of which are hereby incorporated by reference.

### BACKGROUND

### Technical Field

This patent is directed to a radio frequency tag incorporated with a directional antenna.

### Description of the Related Art

Tags include any object with an antenna, electromagnetic field transmission and reception means, and logic or a processor. These tags (e.g. RFID tags, NFC tags, BLE tags, WiFi tags) may be read only or writable. Tags may integrate other devices using electromagnetic induction, through radio waves, or through other communications techniques. Tags also typically perform functions such as identifying and data swapping between other tags using the antenna and logic or processor. Data from auxiliary components coupled to tags may be directly coupled to the processor and relayed wirelessly. Examples of auxiliary components include MEMS accelerometers and acoustic sensors.

Tags may include a transceiver to couple signals back and forth to an antenna. For example, a tag may incorporate a Bluetooth Low Energy (BLE) chipset. A BLE chipset couples with an antenna for reception and sending, and often includes a programmed processor for executing code on the tag. An example is the Cypress Semiconductor PSOC chip. The PSOC can also be electrically connected to auxiliary components. Tags with both receiving and sending hardware and software allow for robust signal calculations to take place. By calculating responses sent to antennas and beacons from tags, identifying information may be compiled. A comparison means may compare identifying information to determine position, angles, speed, direction, and location of objects. Identifying information may enhance the interrogation process as disclosed in U.S. Pat. No. 8,570,168.

As described in U.S. Pat. No. 9,013,360, and incorporated herein by reference, orientation independent (ORIAN) antennas provide an improved solution for antennas. This design allows an antenna to communicate without knowing the orientation of the transmit and receive antennas in advance. The antenna is formed from one or more three dimensional structures that supports sets of radiating elements. These elements are oriented in four different directions—preferably orthogonal. With this orthogonal design the antenna achieves the desired omnidirectional, directional, and polarized modes across a wide frequency range.

Additionally, antennas that are orientation independent can be used in indoor positioning systems as described in U.S. patent application Ser. No. 15/861,739 and incorporated herein by reference.

### SUMMARY

A tag with a directional antenna. The tag uses the directional antenna to ascertain the direction of an item that may be located relative to the device.

### BRIEF DESCRIPTION OF FIGURES

FIG. 1 is an example implementation of an orientation-independent antenna in a tag.

FIG. 2 is an example beamforming circuit in the tag to provide angle of arrival.

FIG. 3 is an alternate arrangement for an orientation-independent antenna.

FIG. 4 is a beamformer used with the orientation-independent antenna of FIG. 3.

FIG. 5 shows additional elements needed to obtain azimuth and elevation.

FIG. 6 is an overview block diagram for an interrogation system that uses the tags according to an illustrative embodiment.

FIG. 7 is an overview flow diagram for establishing communication between the interrogation device and objects according to the illustrative embodiment.

FIG. 8 is an overview flow diagram showing a building implementation of the interrogation system, according to the illustrative embodiment.

### DETAILED DESCRIPTION OF PREFERRED EMBODIMENTS

### I. Device Design

A. Tag Design

The “tags’ discussed herein may be used with a location and/or positioning system which includes a “beacon” or “interrogation” device. The beacon may be part of or include a wireless hub, and the tags may be individual, dedicated, inexpensive radio repeaters attached to items to be tracked such as a set of keys, a wallet, a pet, etc. Tags may also be more complex devices such as smartphones having a wide range of processing capabilities and user interfaces such as touchscreens, or something in-between in terms of complexity such as some other wireless Internet-connected thing. The beacon and tags may communicate with one another using Bluetooth, WiFi, or specialized radio frequencies and protocols dedicated to indoor location and/or positioning functions.

Of interest to the present application is that a tag is equipped with its own directional antenna. Such an antenna allows the tag device to send stronger signals in a given direction, allowing the device to more easily establish and maintain a link with other devices. Such a link might require the device to aim its directional antenna at various angles in order to establish such a link. The tag electronics may be encased by a volumetric orientation independent antenna (ORIAN), or the ORIAN could merely be attached to a tag module if size was not critical. The microcontroller implementing a Bluetooth (BT) function in the tag could also be used to steer the antenna. The antenna is formed from one or more three dimensional structures that supports sets of radiating elements. These elements are oriented in four different directions—preferably orthogonal. With this orthogonal design the antenna achieves the desired omnidirectional, directional, and polarized modes across a wide frequency range.

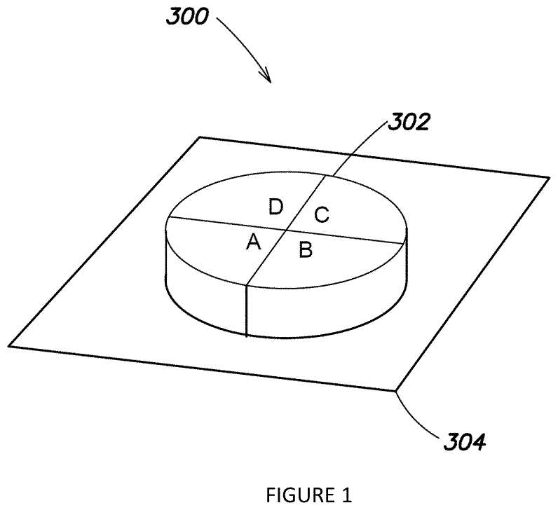

The ORIAN antenna itself, due to its volumetric structure, will typically have more antenna gain than the simple patch antennas used on tags today. FIG. 1 is one example implementation for a steerable, directional, orientation independent antenna 300 used in the tags. It consists of a single volumetric cylindrical element 302 disposed over a ground plane 304. The cylindrical element 302 used in this implementation also consists of a set of quadrant sections A, B, C, D. The antenna operates in the surrounding three dimensional space, with the ground plane 304 parallel to the X-Y plane. A signal of interest may radiate from or radiate to a direction defined by an azimuth angle phi (φ) and elevation angle theta (θ). The signal of interest may have both horizontal (H−) and vertical (V−) polarization components, but the antenna 300 and corresponding beamforming components exhibit orientation independent operation with both horizontal (H−) and vertical (V−) polarizations present in a signal of interest.

In one aspect, the horizontal component H may be suppressed by the cylindrical antenna element 300 if the diameter versus height ratio of the cylinder 302 is relatively large. In one example for operation at 2400 MHz, bandwidth of 200 MHz, a quality factor Q of 12 in a FIG. 1 embodiment, the volumetric cylinder 302 has a diameter of 0.81 inches and a height of 0.16 inches.

It should be understood that ORIAN antenna 300 is packaged in a housing with a power source (such as a battery), one or more of the directional beamformers described above, and other electronics, such as transceivers and processors that detect signals, issue alerts/alarms, and perform other functions of the tag. The small form factor, less than 1 inch across, for a directional antenna 300 is particularly suitable for such small, dedicated tag devices.

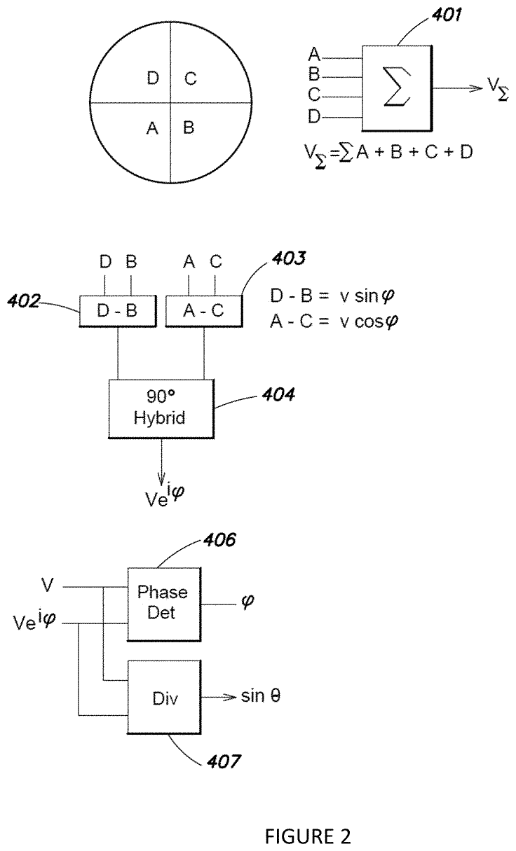

FIG. 2 illustrates a Radio Frequency (RF) beamforming circuit that can be used to produce an orientation independent response from antenna 300 that determines both the azimuth and elevation angles. In this arrangement, a first hybrid combiner 401 produces a signal V_{Σ} representing the sum of signals at the four elements A, B, C, D and, with the suppression of the horizontal component, represents only (or mostly) the vertical component.

A second hybrid power combiner 402, which is a difference, or 180° combiner provides an output signal

D−B=v sin(φ)

and a third 180° hybrid 403 provides

A−C=v cos(φ)

The outputs of combiners 402, 403 feed a 90° quadrature hybrid 404 to produce a signal,

V=ve^{jφ}

proportional to the azimuthal angle.

A phase detector 406 can determine a phase difference 406 between signals V_{Σ} and V thus provides the azimuthal angle, φ. A hybrid divider 407 determines the ratio between them, to produce an output proportional to the elevation angle θ.

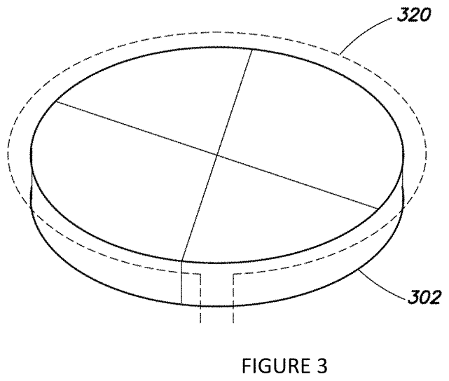

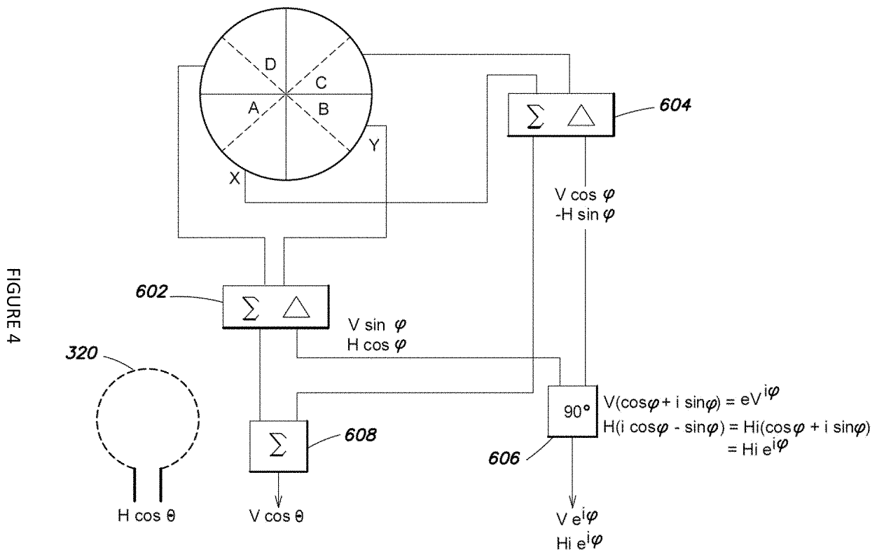

Another implementation shown in FIG. 3 can be used where both horizontal and vertical polarization are present. A circular wire loop 320 is disposed above the cylindrical element 300. As shown in FIG. 4, the output of the wire loop 320 can be combined with other signals to produce a signal proportional to the horizontal component

H cos θ

Hybrid combiners 602, 604 are 180° combiners that provide both a sum and difference output. The 180° hybrid combiners 602, 604, quadrature combiner 606, and combiner 608, arranged as shown, produce signals:

V cos θ

V sin φ

H cos φ

Ve^{jφ}

and

He^{iφ}

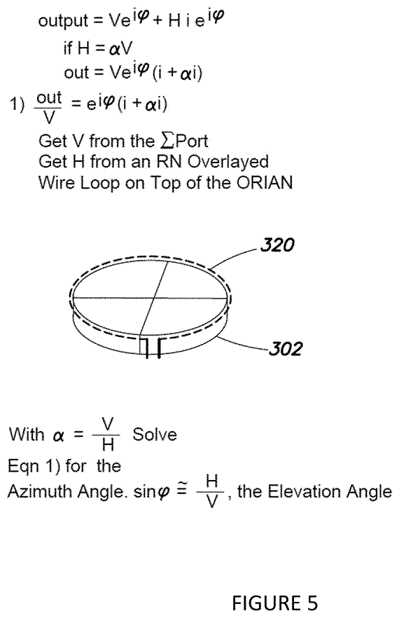

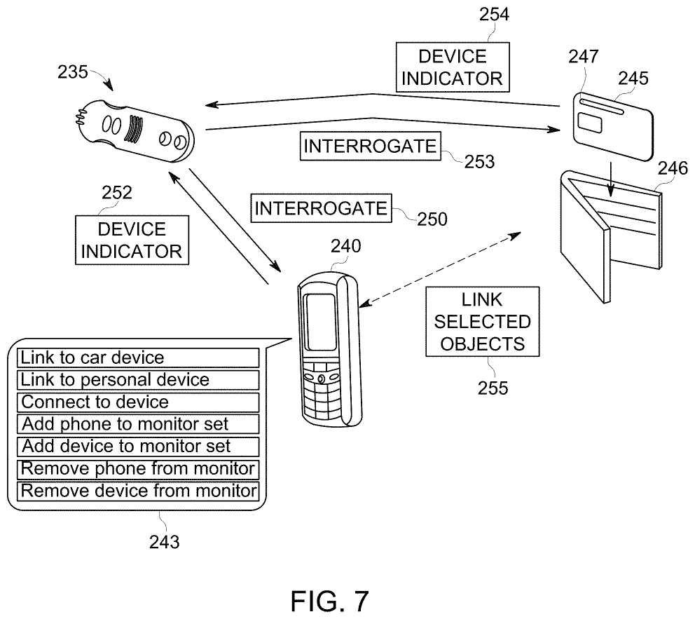

As shown in the equations of FIG. 5, the resulting signals from the hybrid combiners can be further processed to obtain signals representative of both the azimuth and elevation that are independent of any horizontal component and vertical component. For example, Analog-to-Digital Converter(s) (ADCs) may process the outputs of the hybrid combiners and be fed to one or more Digital Signal Processors (DSPs) to perform one or more of the method steps of FIG. 7, thus obtaining an azimuth and elevation.

It can now be understood that various types of orientation-independent antenna arrays can be used to estimate an angle of arrival of received signals. In one configuration, this is done by initially scanning through the available beam directions in both azimuth and elevation with an accuracy of between about 45 and 90 degrees. A subsequent scan can be made with higher accuracy through selective beamforming of the array elements, once the initial estimate of position is made.

More details of ORIAN antennas that may be suitable are described in U.S. Patent Publication 2018/0191079A1, incorporated by reference herein.

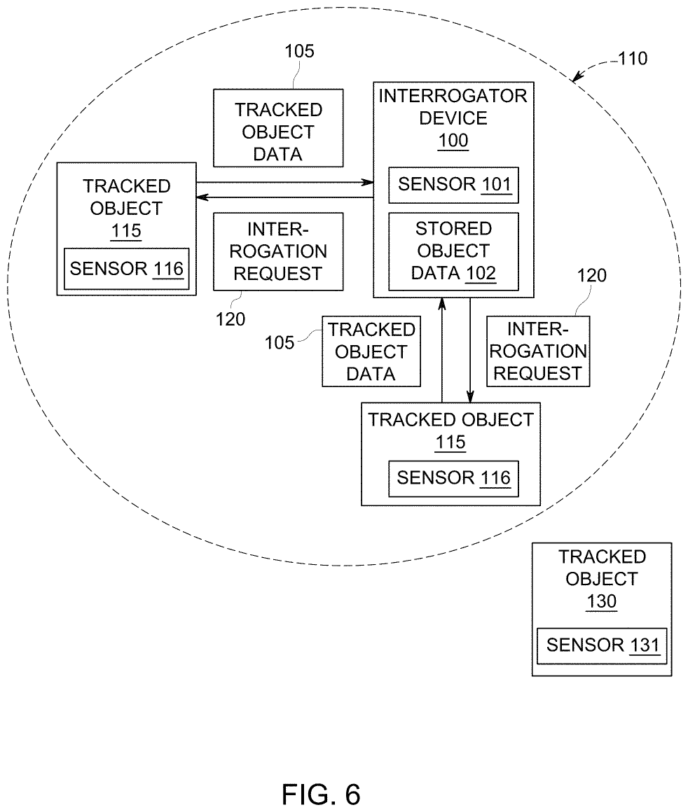

The receiving device or interrogation device or system search for the presence of certain personal items associated with a tag, allowing a user to be notified when that item is absent, has lost power, or is lacking a communication means that it previously had. When an item is present, the system, method and device can control certain functionalities of an item. FIG. 6 shows a block diagram representing an illustrative embodiment of the interrogation system as it is generally used. Interrogator device 100 can be equipped with a communication module 101 or other appropriate element constructed and arranged to communicate with personal items and objects, and more particularly communication modules (116) on these objects in an illustrative embodiment.

The interrogator device 100 can also include stored object data 102 that includes data relating to a plurality of selected or tracked objects 115. These items can include personal belongings, such as a cell phone, wallet, laptop computer, computer bag, or other item a person/user desires to keep track of or keep with them. The dotted line 110 around the interrogator device 100 represents the detectable range of the communication module 101 of the interrogator device 100. The detectable range 110 of the interrogator device 100 is highly variable depending on the particular monitored location and/or area for which selected objects are interrogated. For example, a larger area, for example up to 30 feet away from the interrogator device can be selected when in a house or large building, while a smaller area, for example up to 8 feet, can be chosen for an office space, vehicle or smaller location of interest. The detectable range is generally an area having a radius of detection a specified distance, such as a few feet and up to 30 feet or even further, from the interrogator device. The signal strength generated by any tracked object declines over distance and thus the detectable range can be adjusted by the interrogator by looking for signal strengths above specific thresholds. The signal strength and sensitivity can be set by the manufacturer of the interrogator device to come from the factory with a predetermined detectable range. In further embodiments, an interface can be provided to allow a user to specify the detectable range using conventional circuitry and RF filtering to achieve the desired range of the interrogator device.

Refer to U.S. Pat. No. 6,631,271, filed Aug. 29, 2000, entitled RULES BASED METHODS AND APPARATUS, which is herein incorporated by reference, and U.S. Pat. No. 6,996,402, filed Oct. 7, 2003, entitled RULES BASED METHODS AND APPARATUS FOR GENERATING NOTIFICATION MESSAGES BASED ON THE PROXIMITY OF ELECTRONIC DEVICES TO ONE ANOTHER, which is herein incorporated by reference, for exemplary rule based method and apparatus for relative tracking of objects.

When a trigger event occurs at the particular location equipped with the interrogator device, the event triggers the interrogation of the tracked objects 115. The triggering event can be a person entering a monitored area, or leaving a monitored area, as indicated by detecting that a car has been started or is put into motion, as described in greater detail hereinbelow. The interrogation occurs between interrogation device 100 and tracked object 115 when within the detectable range 110 via datastream 105. Tracked object 115 may also sense a trigger event through communication module 116. Tracked object 115 then transmits, via datastream 120, the tracked object data to interrogation device 100, which uses the data to trigger an interrogation of the tracked objects. The interrogation of tracked object 115 under the condition of trigger event generates a reminder from the interrogator device 100. Further, interrogator device 100 can prompt tracked object 115 for information from communication module 116 of the object 115. The interrogator device 100 can receive information available on tracked object 115 to generate a reminder. Reminders can be generated at interrogator device 100, as well as at the tracked object 115 when initialized by communication from the interrogator device 100.

As shown in FIG. 6, a tracked object 130 that is outside of the detectable range 110 of the interrogator device 100 is not detected by the interrogator device 100. The communication module 131 is thus not able to communicate with the communication module 101 of the interrogator device 100 or the signal strength is not above the threshold as mentioned above, and thus a notification is generated to alert the user that they do not have all of their objects and personal items. The notification can be a textual notification to the user or an audible or visual alarm generated by the interrogator device or a selected object that is within the detectable range. Data pertaining to the tracked objects 115 are stored in the interrogator device as stored object data 102, thereby creating a list of tracked objects within the interrogator device such that once a tracked object is recognized by the interrogator device, it need not be input again to the interrogator device. The interrogator device 100 automatically interrogates for personal items stored therein to prevent the user from leaving behind his or her personal items when such interrogator is positioned in a vehicle, or forgetting to bring them if the case where the interrogator is located in a stationary position such as a room. Once a personal item is detected, the interrogator device 100 can also be employed to control functionality of detected items, as described in greater detail hereinbelow. The system is readily applicable for tracking a single object, such as a cell phone, or a plurality of objects, as so desired.

FIG. 7 shows the elements of the vehicle implementation for interrogating for personal items. The interrogator device 235 communicates with the personal item, electronic device 240, by interrogating the object via datastream 250 and receiving a device indicator (detected or undetected) and other communication data via datastream 252. Electronic device 240 can be a cellular phone, a smart phone, a personal digital assistant, or any device equipped with local and/or wide area communication capabilities. Communication between the electronic device 240 and the interrogator device 235 can be any communications channel, such as Bluetooth, Wi-Fi, infrared, or other radio frequency means of communication such as RFID or Zigbee. In one embodiment, when the electronic device 240 is a cell phone, the means of communication can be the periodic signal sent by such cell phone to a nearby cell phone tower, with such signal able to be received by the interrogator device. Function list 243 shows functions that reside on the electronic device 240 to control the interrogator device. These include a link-to-car device function, a link-to-personal device function, a disconnect-to-device function, an add-phone-to-monitor-list function, an add-device-to-monitor-list function, remove-phone-from-monitor-function and a remove-device-from-monitor-function, to control functionality of the overall system. This is likewise transmitted to the interrogator device via datastream 252.

The interrogator device 235 also interrogates for the selected object 245 via datastream 253, and a device indicator and other communication data is transmitted via datastream 254 back to the interrogator device. Tracked object 245 can be inserted within personal object 246, for this example, a card 245 inserted in the wallet 246. The personal object 246 can be a wallet, a purse, a bag, a keychain, or any object that the person wants to track and the tracked object 245 can include a communication module 247 or other appropriate element communicatively connected to the interrogator device. The electronic device 240 and tracked object 245 can also communicate with each other via datastream 255 as a link is established between the tracked objects via any appropriate communication channel.

Functions 243 on electronic device 240 consist of functions that electronic devices 240 performs to manage the list of devices tracked by interrogator device 235. The user can select different functions from the user interface on electronic device 240. Such functions include being able to link electronic device 240 to interrogator device 235 and unlink said devices, via datastream 255. Electronic device 240 can establish a link between itself and tracked object 245 through function list 243 and also add tracked object 245 to the list of objects being tracked by interrogator device 235. Conversely, mobile device 240 and tracked object 245 can be removed from the tracking list on interrogator device 235 through the function list 243.

The communication established between the interrogation device and the tracked objects allows the user to determine if any personal items are present or, more importantly, if any are not present. As shown, the interrogator device interrogates the tracked object via datastreams 250 and 253, for the electronic device 240 and tracked object 245, respectively. Then an indication of the state of the device, as well as additional communication data if desired, is transmitted to interrogator device 235 via datastreams 252 and 254, such that the interrogator device 235 can determine whether one of the objects under inquiry is not present. The connection between the devices also allows the electronic device 240 and objects 245 to communicate information from their on-board communication module to the interrogator device as device indicator signals via datastreams 252 and 254, respectively. In one embodiment, electronic device 240 and tracked object 245 are equipped with on-board accelerometers. In such embodiments, electronic device 240 and tracked object 245 relay movement readings sensed from their on-board accelerometers to interrogator device 235 through datastreams 252 and 254, respectively.

The interrogator device can be implemented as a pluggable device that is inserted into the car power port. The interrogator device or receiver has a speaker output located on its side. The interrogator device or receiver has controls that can set the interrogator device into a programming mode to listen for the object that is to be added to the monitoring queue. The monitoring queue is a list of tracked objects to be monitored by the interrogator device, as specified by the owner of the tracked objects. The interrogator device uses the monitor queue to determine whether to generate a notification if an object in the list is missing under a circumstance of interest. Additionally, the controls can set the interrogator device into a programming mode to control the removal of objects from the monitoring queue. The interrogator device includes a light indicator that provides indication to the user that the interrogator device is on. The light indicator provides indication that the interrogator device is in a programming mode and it is seeking to add an object to the monitoring queue. Light indicator provides indication that the interrogator device is in programming mode and is seeking to remove an object from the monitoring queue. Light indicator, light indicator, and light indicator are of different color to one another to provide an easy reading to the user.

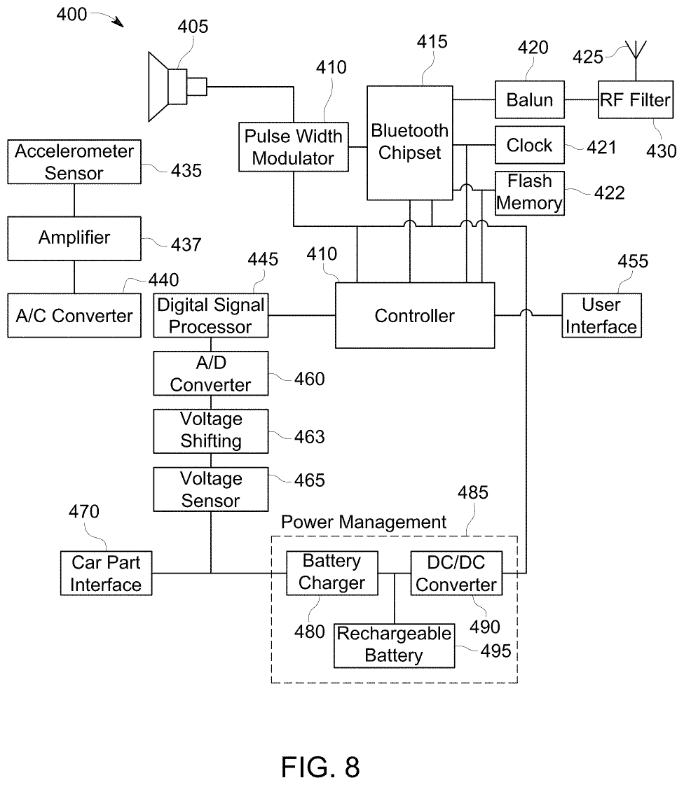

FIG. 8 depicts a schematic diagram illustrating an exemplary architecture of the interrogator device according to the illustrative embodiments. System 400 has two primary controllers that interface with each other: a system controller 450 and communication (i.e. Bluetooth) controller 415. These two controllers can be separate or two sections of a single integrated circuit. The system controller 450 runs the primary software and the high-level function control of the interrogator device. It takes in all the inputs from the communication modules and determines whether a notification should be generated. Communication controller 415 manages all the networking functions on the interrogator device and generates the alert waveform to speaker 405. Digital signal processor 445, which may be part of controller 410, receives inputs from the on-board accelerometer sensor 435 and voltage sensor 465 and provides feedback to system controller 450 as to whether the activity of interest is detected. Power management circuitry 485 draws power from the vehicle power port and provides power for all the circuitry in interrogator device 400.

B. Finding with Directional Antenna

The device could be used to determine the location of another point of interest, device, or item in several ways. In one embodiment the device equipped with a directional antenna sends multiple transmittals in different directions until it establishes a connection with another external antenna. The angle with the strongest link would be presumed to be the direction of the car. This angle would be communicated to the user via lights on the tag, via sounds, via a small display, by voice, or some other interface. Such guidance could made continuously or intermittently as the user approached the desired item.

C. Leash Mode

In another embodiment, the tag is constantly pinging and such continuous pinging will drain down the tag's battery relatively quickly. If the tag could send its RF energy (the ping) in a more focused manner in the direction of the phone then the “volume” of the ping could be set lower thus saving battery life. Alternatively, the standard, higher level of energy could be focused in single direction in order to send a stronger, more focused beam a longer distance. If the tag didn't know in which direction to send the energy, it could send the longer pings in different directions, in sequence, until it located the receiving device. This method reduces the average pinging time if the tag has to send out multiple directional pings in order to close the link. But the benefit is greater range. In summary, with directionality can you can either distance, or battery life, or a little of both.

D. Item Detection

It is not uncommon for users to misplace items. Systems such as those described in the Bringrr patent U.S. Pat. No. 9,716,972, System, Method and Device to Interrogate for the Presence of Objects, incorporated herein by reference, address this problem with equipment that could be added to a car.

Outside of the vehicle context, and in one embodiment, a tag could have a preset location or normal location for an item, such as a certain place to put keys or your phone when a user enters a home. If the tag is not in that location on prior to a certain time an indication or alert condition, including an alarm could be generated.

These alert conditions or alarms, and alert conditions or alarms for other tags, could be turned on or off by the user via an app, for any tag. A more general setting could mandate that there be an alarm for any tag, which had been programmed to be in the car before starting a trip, not be left behind.

In another embodiment, an alarm could sound if a tag is left in a certain place for a given amount of time. For instance, if you leave keys in the car, after a set interval of time, an alarm or notification might appear.

The foregoing description of example embodiments provides illustration and description of systems and methods for implementing a tag with an integrated, directional, orientation independent antenna, but is not intended to be exhaustive or to limited to the precise form disclosed.

For example, it should be understood that the embodiments described above may be implemented in many different ways. In some instances, the various computers or processors described herein may each be implemented by a separate or shared physical or virtual general purpose computer having a central processor, memory, disk or other mass storage, communication interface(s), input/output (I/O) device(s), and other peripherals. The general purpose computer is transformed into the processors with improved functionality, and executes the processes described above to provide improved operations. The processors may operate, for example, by loading software instructions, and then executing the software instructions to carry out the functions described. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof. and designed to achieve the greatest per-unit efficiency possible. Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and network diagrams may include more or fewer elements, be arranged differently, or be represented differently. It further should be understood that certain implementations may dictate the block and network diagrams and the number of block and network diagrams illustrating the execution of the embodiments be implemented in a particular way.

Other modifications and variations are possible in light of the above teachings. For example, while a series of steps has been described above with respect to the flow diagrams, the order of the steps may be modified in other implementations. In addition, the steps, operations, and steps may be performed by additional or other modules or entities, which may be combined or separated to form other modules or entities. For example, while a series of steps has been described with regard to certain figures, the order of the steps may be modified in other implementations consistent with the principles of the invention. Further, non-dependent steps may be performed in parallel. Further, disclosed implementations may not be limited to any specific combination of hardware.

The above description of the embodiments, alternative embodiments, and specific examples, are given by way of illustration and should not be viewed as limiting. Further, many changes and modifications within the scope of the present embodiments may be made without departing from the spirit thereof, and the claims that follow are intended to include such changes and modifications.

1. An item tracker comprising:
a power source;
an antenna structure comprising:
a set of antenna elements, the elements including at least four radiating segments, with each segment generally facing in a selected one of four different orthogonal directions;
at least two of the radiating segments providing a respective horizontal and vertical polarization;
a selector module situated within the antenna structure, the selector module providing at least a horizontal and vertical polarization transmission line extending from corresponding horizontal and vertical polarization segments of the four sets of radiating elements; and
a combining circuit connected to the transmission lines, to selectively enable a directional mode, omnidirectional mode, and polarization modes.
the antenna configured to send one or more radio frequency (RF) transmissions in different selected directions;
the item tracker configured to provide an alert condition when a receiving device receives a predetermined one or more RF transmissions.

2. The item tracker of claim 1 wherein the alert condition is an audible alarm.

3. The item tracker of claim 1 wherein the alert condition is one or more flashing lights.

4. The item tracker of claim 1 wherein the item tracker is a mobile electronic device.

5. The item tracker of claim 1 wherein the item tracker is a Bluetooth tag.
